(19) United States
(12) Patent Application Publication
(10) Pub. No.: US 2010/0196569 A1
(43) Pub. Date: Aug. 5, 2010

(54) QUINOA GRAIN PROCESSING AND PRODUCTS

(75) Inventors: Laurie A. Scanlin, Arvada, CO (US); Claire Burnett, Erie, CO (US)

Correspondence Address: SMITH HOPEN, PA, 180 PINE AVENUE NORTH, OLDSMAR, FL, 34677, US

(73) Assignee: KEEN INGREDIENTS, INC., Louisville, CO (US)

(21) Appl. No.: 12/756,525

(22) Filed: Apr. 8, 2010

Related U.S. Application Data
(63) Continuation of application No. PCT/US2008/079185, filed on Oct. 8, 2008.
(60) Provisional application No. 60/978,339, filed on Oct. 8, 2007.
(60) Provisional application No. 60/978,348, filed on Oct. 8, 2007.

(51) Int. Cl. A23L 1/212; A23L 3/40

(52) U.S. Cl. 426/464; 426/465; 426/456

(57) ABSTRACT

Quinoa grain products having a reduced bitter flavor with a sweet taste or crunchy texture. Despite numerous beneficial properties, quinoa grain has not been utilized in a wide variety of products. Provided are efficient processes for quinoa to obtain additional products and to process the quinoa grain to yield components for food ingredients. The dried edible quinoa product is particularly useful to flavor and/or texture bakery products, nutrition bars, granolas, confections and chocolates. It can withstand additional and/or extreme food processing and can be used as a replacement for allergenic nuts, seeds, and sesame seeds. The sweet quinoa product is particularly useful to flavor and/or sweeten, or function as humectants, in bakery products, nutrition bars, beverages, and coffee and tea products and can serve as a replacement or partial replacement of corn syrup and brown rice syrup. Lastly, the quinoa products are considered to be hypo-allergenic.

### CROSS REFERENCE TO RELATED APPLICATIONS

This application is a continuation of International Application No. PCT/US2008/079185, filed Oct. 8, 2008, which claims priority to (1) U.S. Provisional Patent Application 60/978,339, entitled, “Method for Treating Quinoa Grain and the Edible Product Obtained Having Novel Texture, Flavor, and Extended Shelf-Life and Uses Thereof”, filed Oct. 8, 2007, and to (2) U.S. Provisional Patent Application 60/978,348, entitled, “Method for Treating Quinoa Grain and the Edible Sweet Liquid and Sweet Powdered Product Obtained and Uses Thereof”, filed Oct. 8, 2007, the contents of which applications are herein incorporated by reference.

### FIELD OF INVENTION

The present invention relates to methods for processing quinoa (Genus: Chenopodium, Species: quinoa, Family: Chenopodiaceae) grain (also called quinoa seed, quinua, grain-like seed, pseudocereal, and fruit) to produce products having a sweet taste or crunchy texture and reduced bitter flavor.

### BACKGROUND OF THE INVENTION

Quinoa is a grain that is native to the Andean region of South America. The grain has been a major food source for about 6,000 years, serving as a staple food for native inhabitants of the region including the countries of Chile, Peru and Bolivia. Following the arrival of the Spanish in about 1500, quinoa production began to decline in the region, eventually becoming a minor crop that was grown only in remote regions for local consumption.

Unlike other staple food sources from the New World, such as potatoes and maize, quinoa was not widely adopted or spread throughout the globe. Quinoa has only been grown outside of South America for a relatively short time. Since 1975, quinoa has become an alternative crop in North America and Europe for many reasons including that (1) quinoa has the ability to thrive in marginal soils, where traditional crops cannot, therefore, underutilized growing regions can be cultivated; (2) quinoa has an average protein content of 14.6%, which is higher than traditional cereals, with certain varieties containing protein levels as high as 21.9%; (3) and quinoa has an amino acid composition, protein efficiency ratio, protein digestibility, and nitrogen balance comparable to milk protein, casein [Fleming and Galwey (1995) In: Williams, J T, editor. Underutilized Crops: Cereals and Pseudocereals. New York: Chapman and Hall, ppg. 3-83]. Few plant proteins so closely resemble that of animal origin as quinoa protein.

As world food demands steadily increase, greater demands will be made for nutritious crops that can be grown under less optimal conditions. Plant proteins from cereals and legumes represent the main source of proteins and energy supply for both human and animal nutrition. This is partly due to the fact that animal proteins require much higher energy demand for production and are therefore more expensive to produce than plant proteins [Cheftel, J C et al. (1985) In: Fennema O R, editor. Food Chemistry, 2^{nd} ed. New York: Marcel Dekker. ppg. 245-369]. For example, in order to produce 1 kg of animal protein, 3-20 kg of plant protein is needed. Consequently, as demands for animal protein increase globally, the need for plant protein increases drastically. To meet this need, new protein resources must be developed. Protein-rich crops that give equitable yields in underutilized growing regions are of paramount value for this purpose.

Plant proteins, processed from cereal grains and legumes, are profitable ingredients in a wide variety of commercial food products, pet foods, and animal feed. However, plant proteins are often limiting in one or more essential amino acids. For example, the plant proteins of wheat, rice and corn are limiting in lysine [Hoseney, R C (1986) In: Principles of cereal science and technology. St. Paul, Minn.: American Association of Cereal Chemists, Inc. ppg. 69-88], whereas, soy protein is limiting in methionine and cystine [Haard and Chism (1996) In: Fennema O R, editor. Food Chemistry, 3^{rd} ed. revised and expanded. New York: Marcel Dekker, ppg. 943-1011]. Well-processed isolated soy proteins and soy protein concentrates have been found to be equivalent to animal protein in regard to the needs of human nutrition [Young, V R (1991) J. Am. Diet Assoc. 7: ppg. 828-835].

Quinoa protein is particularly high in lysine and methionine, amino acids limiting in cereal grains and legumes, respectively [Koziol, M J (1992) J. Food Composition and Analysis 5: ppg. 35-68]. Quinoa protein is also high in histidine, an essential amino acid for infant development and those with chronic diseases [Ettinger, S (2000) In: Mahan K L, Escott-Stump S, eds. Krause's Food, Nutrition, and Diet Therapy, 10^{th} ed. Philadelphia, Pa. WB Saunders Co. ppg. 54-61]. In South America, it has been used as a weaning food for centuries because of its nutritional attributes and high protein digestibility.

Another source of concern for many plant products and/or protein sources is the potential for allergenic reaction. The following eight foods, while they are a good source of animal or plant protein, account for 90% of all food allergenic reactions; soy, wheat, eggs, milk, peanut, tree nuts, fish and shellfish [Hefle, S. L. et al. (1996) Crit. Rev. Food Sci. Nutr. 36(5): ppg. 69-89]. Food allergens are a serious concern because essential nutrients for proper health can be missing with a narrowed food choice imposed by a restricted diet, in addition to the life-threatening concern of anaphylactic shock in highly sensitive individuals. Allergens are problematic for food producers because many food ingredients fall into this category and limit product development. The impact that food allergens, including undeclared food allergens, have had on the food industry is significant and the FDA has made food allergens a top priority in recent years [Hefle, S. (September 2003) Symposium: Update on Food Allergens. American Association of Cereal Chemists Annual Meeting. Portland, Oreg.].

Quinoa is not on the list of recognized food allergens. It is considered free of gluten or prolamins [Fairbanks, O J et al. (1990) Plant Breeding 104(3): ppg. 190-195], the protein associated with allergenic reactions in wheat gluten, rye and barley. Prolamins, like gliadins found in wheat, trigger immune responses in patients with gluten-induced enteropathy, also known as celiac disease. Quinoa is a pseudocereal named for its production of small grain-like seeds, although the actual harvested grain is a single seeded fruit [Shewry, P R (2002) In: Belton P S, Taylor J. eds. Pseudocereals and Less Common Cereals. Germany: Springer-Verlag Berlin Heidelberg. ppg. 93-122]. It is a dicotyledonous species not closely related to the monocotyledonous species of true cereal grains like wheat, rye, and barley. As a result of differences in plant taxonomy, quinoa does not contain the harmful amino acid sequences found in wheat. Therefore, it is concluded safe for a gluten-free diet [Thompson, T. (2001) J. Am. Diet. Assoc. 101: ppg. 586-587] and is recommended by the Celiac Disease Foundation and Gluten Intolerance Group. Furthermore, research presented at the International Workshop on Food Supplementation in Food Allergy and Immunity, found that quinoa is immunochemically safe and represents a viable alternative for gluten-free products [Berti, C et al. (August 2002) International Workshop on Food Supplementation in Food Allergy and Immunity. Olsztyn].

Despite the numerous beneficial properties of quinoa as a plant protein source as described above, quinoa grain has not been utilized in a wide variety of products. Currently, quinoa is available only as whole grain or ground for a small number of products. Therefore, there is a need in the art to develop a method to process quinoa grains into additional products and to process the quinoa grain to yield components that can be added as ingredients to foods. The present invention meets these important needs. The advantages of the invention will be evident in the following description.

### SUMMARY OF INVENTION

The present invention provides new products produced from the novel processing of quinoa grain. Interest in quinoa grain has been high due to its ability to be cultivated in marginal/underutilized growing regions and the excellent nutritional profile of the grain. However, there has been relatively few products available utilizing quinoa, due in part to some undesirable characteristics of the grain. For instance, unprocessed quinoa tends to have a bitter or unpleasant taste. This taste can be attributed to the saponins that are concentrated in the peri-carp of quinoa. Also, flaked or whole grain quinoa may not offer the proper texture when used as an ingredient for finished products. The new products produced by the novel methods of the invention add significantly to the repertoire of uses to which the quinoa grain can be used.

In a first aspect the present invention provides an edible quinoa product having a novel texture, taste and an extended shelf life. Also provided is the novel process for producing the edible quinoa product using grain from Chenopodium quinoa. The method can be characterized by the steps of: 1) pre-conditioning quinoa grain; 2) moist heating the quinoa grain; and 3) dry heating the quinoa grain to produce a “quinoa crisp”. The quinoa crisps can be further treated by drying, tempering, milling, grinding, coating, flavoring, and/or salting if necessary. Pre-conditioning, as in step (1) above, can be accomplished by mechanical abrasion, washing, polishing, peeling, aspiration, air classification, sieving, pneumatic pressure, vacuum, nixtamalization, rinsing, solvent leaching the quinoa grain and combinations thereof. Advantageously, pre-conditioning of the quinoa grain is accomplished by mechanical abrasion, washing the quinoa grain and combinations thereof. In a particularly advantageous embodiment, pre-conditioning employs a plurality of washes in clean water with a first wash duration of about 30 seconds to about 2 minutes and subsequent wash durations of about 2 minutes to about 10 minutes. Pre-conditioning serves to remove saponins from the peri-carp of the grain, while minimizing penetration of the saponins into the grain.

In a second aspect the present invention provides an edible sweet quinoa product that has a high sugar content in comparison to the quinoa grain from which it is produced. Also provided is the novel process for producing the sweet quinoa product using grain from Chenopodium quinoa. The method can be characterized by the steps of: 1) pre-conditioning quinoa grain; 2) conditioning the quinoa grain; 3) germination of the quinoa grain to produce green quinoa malt; 4) incubation of the quinoa malt; 5) conversion of the quinoa malt; and 6) reduction of the quinoa malt digest to produce a sweet quinoa product. The sweet quinoa product can be refrigerated, frozen, retorted, or dehydrated in its liquid form to extend the shelf-life. Dehydration of the sweet quinoa product from its liquid form intensifies the sweetness and allows the product to be used as a powdered sweetener in food and beverages, such as coffee and tea applications, which may require dry ingredients. The sweet quinoa product can be further treated by techniques including drying, tempering, filtration, purification, bleaching, maturation, enzymatic or acid hydrolysis, and/or cooking if necessary.

Quinoa is considered to be hypo-allergenic (even non-allergenic), as opposed to key plant allergens, soy and wheat. Therefore, the quinoa crisps and sweet quinoa product are useful as food ingredients and supplements to provide nutrients as well as necessary functionality in a variety of food products including infant formula, pet foods and animal feeds. For example, the quinoa crisps of the invention are particularly useful to flavor and/or texture bakery products, nutrition bars, granolas, confections and chocolates. Quinoa crisps can withstand additional and/or extreme food processing, such as retorting. The quinoa crisps can also be used as a replacement, or partial replacement, of allergenic nuts, seeds, and sesame seeds. The sweet quinoa product of the invention is particularly useful to flavor, and/or sweeten, or function as humectants in bakery products, nutrition bars, beverages, and coffee and tea products. The sweet quinoa product of the invention is also particularly useful as a replacement or partial replacement of corn syrup and brown rice syrup.

### BRIEF DESCRIPTION OF THE DRAWINGS

For a fuller understanding of the invention, reference should be made to the following detailed description, taken in connection with the accompanying drawings, in which:

FIG. 1 is a flowchart illustrating an exemplary method for the preparation of an edible quinoa product having novel texture, taste and extended shelf-life from Chenopodium quinoa, Chenopodiaceae.

FIG. 2 is a flowchart illustrating an exemplary method for the preparation of edible sweet liquid product and sweet powdered product from Chenopodium quinoa, Chenopodiaceae.

### DETAILED DESCRIPTION OF THE PREFERRED EMBODIMENT

In general the terms and phrases used herein have their art-recognized meaning, which can be found by reference to standard texts, journal references and contexts known to those skilled in the art. The following definitions are provided to clarify their specific use in the context of the invention.

The term, “quinoa crisp”, as used herein, is intended to indicate the product obtained from quinoa (Genus: Chenopodium, Species: quinoa, Family: Chenopodiaceae) grain (also called quinoa seed, grain-like seed, pseudocereal, and fruit) produced by the cooking and dehydration of individual seeds that have the intact embryo and perisperm of the native quinoa grain and minimal volume expansion of starch.

The term, “sweet quinoa product”, as used herein, is intended to indicate the product obtained from quinoa (Genus: Chenopodium, Species: quinoa, Family: Chenopodiaceae) grain (also called quinoa seed, grain-like seed, pseudocereal, and fruit) produced by the enzymatic conversion of the grain's starch to sugar.

The term, “functionality”, is a well-known term in the food industry and relates to physical and chemical properties of food molecules that affect their behavior and produce desired effects in foods during formulation, processing, preparation, and storage [Murano, P S (2003) Understanding Food Science and Technology. Belmont, Calif.: Wadsworth/Thomson Learning, Inc.]

The term, “infant food”, more commonly referred to as “food for infants” means any food product intended for use for infants up to one year in age, and generally refers to solid foods for older infants age six months to one year in age. “Foods for toddlers” generally refers to foods for toddlers age one year to two years in age. “Foods for children” refers to foods for pre-school children age 2-5 years and schoolchildren up to 12 years in age. The designation becomes important when estimating amino acid requirements.

When a Markush group or other grouping is used herein, all individual members of the group and all combinations and sub-combinations possible of the group are intended to be individually included in the disclosure. Whenever a range is given in the specification, for example, a temperature range, a time range, or a composition range, all intermediate ranges and sub-ranges, as well as all individual values included in the ranges given are intended to be included in the disclosure.

As used herein, “comprising” is synonymous with “including,” “containing,” or “characterized by,” and is inclusive or open-ended and does not exclude additional, un-recited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The term “about”, as used herein, refers to such normal variation in that quantity as would be expected by the skilled artisan.

The terms and expressions which have been employed in the detailed description of the invention are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### Example 1

### Method for Treating Quinoa Grain and the Edible Product Obtained Therefrom

The present invention provides methods for treating quinoa grain or seeds to produce a cooked and dehydrated edible product having novel taste and texture. Also provided is a novel edible product, referred to herein as “quinoa crisps”, prepared from quinoa (Chenopodium quinoa) grain. Additionally, numerous uses for the novel edible product produced according to the methods are taught herein.

Whole grain quinoa (intact native seed) or whole grain quinoa flakes are currently added to a few bakery and food products, primarily to develop a multi-grain food product. Despite their limited use, there are a number of obstacles to the widespread use of the whole quinoa grain or whole grain quinoa flakes in food products. Some of the obstacles are that: (1) the quinoa may be undercooked in the finished product; (2) the quinoa may be fully cooked and have a high water activity; (3) the quinoa may impart a mushy or gritty texture; (4) the quinoa may not withstand extreme food processing, such as retorting; (5) the quinoa may have a bitter or unpleasant taste; and/or (6) the quinoa may have limited shelf life due to high water activity and/or increased enzymatic activity.

The bitter or unpleasant taste can be attributed to saponins that are concentrated in the peri-carp of quinoa grain. Saponins are a group of amphipathic plant glycosides that form soapy lathers when mixed and agitated with water. They are frequently used in detergents, foaming agents, and emulsifiers. Saponins are often bitter to taste, reducing plant palatability to livestock and other animals ingesting the saponin-containing plant (e.g., in livestock feeds), or even imbue them with potentially life-threatening toxicity, depending upon the plant species and the quantity ingested. Reducing the bitter taste associated with the saponins in the quinoa will lead to an enhanced flavor and greater acceptance of quinoa as an alternative source of nutrition.

In addition to the whole grain quinoa or whole grain quinoa flakes, puffed individual quinoa grain is also available. There are many short-comings to this product, with associated obstacles to its use as an ingredient in other finished products. One short-coming to the use of puffed individual quinoa grain is that the embryo is partially driven off during starch expansion, and therefore, many nutrients found in the embryo and intact grain are lost. Another short-coming of puffed individual grain is that the expanded starch in the puffed individual grain is hydroscopic. A consequence of this is that, like popped corn, the texture of puffed individual quinoa grain becomes rubbery over time. This results in the puffed individual quinoa grain having a limited shelf-life and limited application as an ingredient for food manufacturers.

In contrast, quinoa crisps of the invention have a hard, crunchy texture and a nutty, toasted, fresh cereal grain taste. They also have an extended shelf-life as a food ingredient without the need for a sugary coating or moisture barrier. The quinoa crisps of the invention are cooked, toasted and dehydrated individual seeds that have the intact embryo and perisperm of the native quinoa grain and minimal volume expansion of starch. The quinoa crisps of the invention also contain a similar nutrient profile to that of the intact grain. Currently, there are no available quinoa crisps today. The methods described herein for the manufacture of quinoa crisps of the invention are designed with consideration of the physical structure of quinoa grain and for industry-scale production.

Considerable interest has been focused on the need to develop hypo-allergenic food sources. Allergens and allergenic proteins are an extremely significant problem for food producers because so many food ingredients fall into these categories. This limits product development and the options available to food producers seeking to market safe products for individuals susceptible to the allergens. A wide variety of ingredients and food products contain allergenic proteins, such as milk, eggs, fish, crustacean shellfish, tree nuts, wheat, peanuts, soybeans, and gluten proteins from wheat, barley, rye, triticale, and oat. In contrast, quinoa crisps contain hypo-allergenic proteins. Therefore, the quinoa crisps are useful as hypo-allergenic food ingredients and supplements to provide texture and nutrients, as well as necessary functionality, in a variety of food products.

The quinoa crisps produced according to the methods of the invention have numerous applications. For example, the quinoa crisps can be used in bakery products, desserts, tortillas, crackers, granolas, toppings, batters and coatings, confections, breakfast cereal, instant and cook-up porridge, pudding or tapioca-like pudding, dairy foods, snack and extruded foods, frozen foods, retorted foods, ready-to-eat packaged foods, nutrition bars, meat extenders, meat analogs, seasoning and dry ingredient mixes.

Quinoa crisps of the invention are particularly useful to flavor and/or texture bakery products, nutrition bars, granolas, confections and chocolates. Quinoa crisps can withstand additional and/or extreme food processing, such as retorting. The quinoa crisps can also be used as a replacement, or partial replacement, of allergenic nuts, seeds, and sesame seeds.

The quinoa crisps can be used in milk-free and dairy-free, soy-free, nut-free, peanut-free, gluten-free, and egg-free food or cosmetic products. This is particularly important for subjects who require less- or hypo-allergenic food products. The quinoa crisps can be used in plant-based, vegan, vegetarian, non-GMO and non-genetically engineered, natural and organic foods. In addition, quinoa crisps can serve as an ingredient in pet foods and animal feeds, such as cattle feed. These usages take on added importance following the FDA's ban on animal protein in cattle feed as a preventative measure against bovine spongiform encephalopathy (i.e., BSE or mad cow disease) [DEPARTMENT OF HEALTH AND HUMAN SERVICES (2004), Food and Drug Administration, 21 CFR Parts 189 and 700, [Docket No. 2004N0081], RIN-0910-AF47, Use of Materials Derived From Cattle in Human Food and Cosmetics].

Method:

Overview of Method of Making Quinoa Crisps:

The present invention provides a non-obvious method for manufacturing quinoa crisps of the invention. The method can be characterized by the steps of: 1) pre-conditioning quinoa grain; 2) moist heating the quinoa grain; and 3) dry heating the quinoa grain. The method yields an edible quinoa product according to the invention with novel characteristics as discussed more fully above. The quinoa crisps can be further treated by drying, tempering, milling, grinding, coating, flavoring, and/or salting if necessary. Prior to pre-conditioning, conditioning, or germination, quinoa grain can be sorted by size, shape, or color to aid in quality of finished products.

Detailed Method of Making Quinoa Crisps:

Pre-Conditioning:

The term “pre-conditioning” is used herein to indicate a step of treatment to remove saponins in the quinoa grain. Saponins are concentrated in the pericarp of quinoa. Saponin removal can be achieved via mechanical abrasion, washing, or a combination of both. A preferred pre-conditioning includes abrasion followed by an initial quick wash with stiffing, agitation or spray or counter current extraction immediately followed by draining or centrifugation to minimize penetration of the water-soluble saponins into the seed coat. This is followed by a second wash with stirring or agitation followed by draining or centrifugation. The number of washings can be adjusted in the range of one to ten washings, preferably about 2. The ratio of quinoa to water (w/v) can be adjusted to include ratios such as 0.1:1 or 0.5:1; 2:1; 3:1; 4:1; 5:1; 20:1 or similar ratios, preferably 1:1. Residence time of initial quick wash and secondary wash can be adjusted in the range of (about) 30 seconds to 60 minutes depending on a given variety of quinoa; preferably 30 seconds to 2 minutes for the initial wash and 2 minutes to 10 minutes for one or more of the secondary washes, most preferably (about) 1 minute for initial quick wash and (about) 5 minutes for secondary wash. Preferably, pre-conditioning is immediately followed by cooking. Alternatively, pre-conditioning can include polishing, peeling, aspiration, air classification, sieving, pneumatic pressure, vacuum, nixtamalization, rinsing, and/or solvent leaching. The pre-conditioning step described herein is preferably immediately followed by conditioning.

Moist Heating:

The term “moist heating” is used herein to indicate a step of treatment whereby the quinoa grain is heated in a moist environment, such as steam cooking or pressure cooking. Preferably, the outer grain is moistened from pre-conditioning but the inner grain is not allowed to temper, equilibrate or absorb moisture from pre-conditioning. A preferred moist heating technique includes steaming quinoa grain immediately after pre-conditioning. The quinoa grain is placed on screens or placed in a container separated from water and does not come into direct contact with water other than water produced by condensed steam. The quinoa grain is in contact with steam and is heated and cooked until the individual grains are translucent. Residence time of moist heating can be adjusted in the range of 30 seconds to 720 minutes depending on a given variety of quinoa, preferably about 20 minutes to about 60 minutes, most preferably about 30 minutes. Alternatively, moist heating can include pressure cooking.

The term “dry heating” is used herein to indicate a step of treatment whereby the quinoa grain is heated in a dry environment, such as baking, toasting and/or dehydrating. A preferred dry-heating includes an initial bake in a convection oven followed by a second bake in a convection oven. The baking temperatures can be adjusted in the range of 0° F.-700° F. and baking times can be adjusted in the range of 10 sec to 1440, preferably about 225-275° F. for about 7-15 minutes for initial bake and about 500-600° F. for about 1-3 minutes for second bake, most preferably about 250° F. for about 10 minutes for initial bake and about 550° F. for about 2 minutes for second bake.

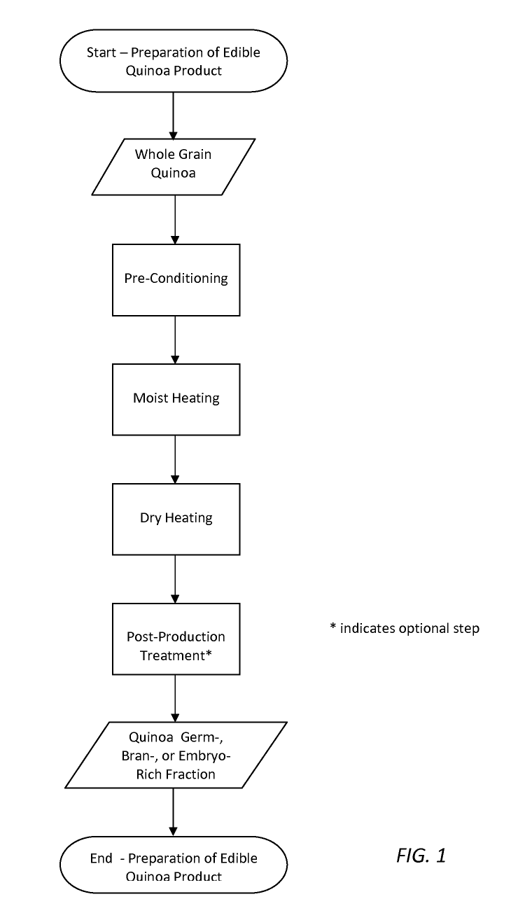

Processing the grain as outlined above produces a novel edible quinoa product. It will be understood by those skilled in the art that the process disclosed herein can be operated with appropriate modifications and variations to obtain the afore-mentioned products. The process disclosed in this example and illustrated in FIG. 1 is designed to yield edible quinoa crisps with novel characteristics as discussed above.

### Example 2

### Method for Treating Quinoa Grain and the Edible Sweet Liquid and Sweet Product Obtained Therefrom

In a second aspect the present invention provides methods for treating quinoa grain or seeds to produce an edible product having novel sweet taste. Also provided is a novel edible product obtained from quinoa, referred to herein as “sweet quinoa product”, which is prepared from quinoa (Chenopodium quinoa) grain. Additionally, numerous uses for the novel edible product produced according to the methods taught herein.

The sweet quinoa product of the invention has a high sugar content in comparison to quinoa grain. There is no commercially available sweet quinoa product today. The method described herein for the manufacture of sweet quinoa product of the invention is designed with consideration of the physical structure of the sweet quinoa product and for industry-scale production.

Considerable interest has been focused on the need to develop hypo-allergenic food sources, with particular interest in hypo-allergenic proteins. The sweet quinoa product of the invention contains hypo-allergenic proteins, as opposed to allergenic proteins from milk, egg, fish, crustacean shellfish, tree nuts, wheat, peanuts, soybeans, and gluten proteins from wheat, barley, rye, triticale, and oat. Therefore, the sweet quinoa product is useful as hypo-allergenic food ingredients and supplements to provide sweetness and nutrients as well as necessary functionality in a variety of food products.

The sweet quinoa product produced according to the methods of the invention has numerous applications. For example, the sweet quinoa product of the invention can be used in a wide variety of products including but not limited to bakery products, desserts, frostings, tortillas, crackers, granolas, toppings, batters and coatings, confections, breakfast cereal, instant and cook-up porridge, pudding or tapioca-like pudding, dairy foods, snack and extruded foods, frozen foods, beverages, milk-like beverages, ready-to-eat packaged foods, foods for infants and toddlers, nutrition bars, meat extenders, meat analogs, pastas, dough, sauces, seasoning and dry ingredient mixes, flavorings, malt beverages, fermented alcohol spirits. The sweet quinoa product of the invention is particularly useful to flavor and/or sweeten, or function as humectants, in bakery products, nutrition bars, beverages, and coffee and tea products. The sweet quinoa product of the invention is also particularly useful in the production of vegan, milk-like, beverages. The sweet quinoa product of the invention is particularly useful as a replacement or partial replacement of corn syrup and brown rice syrup.

The sweet quinoa product can be used in milk-free and dairy-free, soy-free, nut-free, peanut-free, gluten-free, and egg-free food or cosmetic products intended for use in subjects who require less- or hypo-allergenic food products. The sweet quinoa product can be used in plant-based, vegan, vegetarian, non-GMO and nongenetically engineered, natural and organic foods. In addition, sweet quinoa product can serve as an ingredient in pet foods and animal feeds, such as cattle feed, in replacement of the FDA-banned use of animal protein in cattle feed, which ban was instituted as a preventative measure against bovine spongiform encephalopathy (i.e., BSE or mad cow disease) [DEPARTMENT OF HEALTH AND HUMAN SERVICES (2004), Food and Drug Administration, 21 CFR Parts 189 and 700, [Docket No. 2004N0081], RIN-0910-AF47, Use of Materials Derived From Cattle in Human Food and Cosmetics].

Method:

Overview of Method of Making Sweet Quinoa Product:

The present invention provides a non-obvious method for manufacturing sweet quinoa product. The method can be characterized by the steps of: 1) pre-conditioning quinoa grain; 2) conditioning the quinoa grain; 3) germination of the quinoa grain to produce green quinoa malt; 4) incubation of the quinoa malt; 5) conversion of the quinoa malt; and 6) reduction of the quinoa malt digest. The method yields a sweet liquid quinoaproduct with concentrated sugar profile with the novel characteristics as discussed more fully above. The sweet quinoa product can be refrigerated, frozen, retorted, or dehydrated in its liquid form to extend the shelf-life. Dehydration of the sweet quinoa product from its liquid form intensifies the sweetness and allows the product to be used as a powdered sweetener in food and beverages, such as coffee and tea applications, which may require dry ingredients. The sweet quinoa product can be further treated by techniques including drying, tempering, filtration, purification, bleaching, maturation, enzymatic or acid hydrolysis, and/or cooking if necessary. Prior to pre-conditioning, conditioning, or germination, quinoa grain can be sorted by size, shape, or color to aid in quality of finished products.

Detailed Method of Making Sweet Quinoa Product:

Pre-Conditioning:

The term “pre-conditioning” is used herein to indicate a step of treatment to remove saponins in the quinoa grain. Saponins are concentrated in the pericarp of quinoa. Saponin removal can be achieved via mechanical abrasion, washing, or a combination of both. A preferred pre-conditioning includes abrasion followed by an initial quick wash with stiffing, agitation or spray or counter current extraction immediately followed by draining or centrifugation to minimize penetration of the water-soluble saponins into seed coat. The initial quick wash is followed by a second wash with stirring or agitation followed by draining or centrifugation. The number of washings can be adjusted in the range of one to ten washings, preferably about 2. The ratio of quinoa to water (w/v) can be adjusted to include ratios such as 0.1:1 or 0.5:1; 2:1; 3:1; 4:1; 5:1; 20:1 or similar ratios, preferably 1:1. Residence time of the initial quick wash and the secondary wash can be adjusted in the range of 30 seconds to 60 minutes depending on a given variety of quinoa; preferably about 30 seconds to about 2 minutes for the initial wash and about 2 minutes to about 10 minutes for one or more of the secondary washes, most preferably (about) 1 minute for initial quick wash and (about) 5 minutes for secondary wash. Alternatively, pre-conditioning can include polishing, peeling, aspiration, air classification, sieving, pneumatic pressure, vacuum, nixtamalization, rinsing, and/or solvent leaching. The pre-conditioning step described herein is preferably immediately followed by conditioning.

Conditioning:

The term “conditioning”, or “conditioned”, is used herein to indicate treatment to adjust the moisture content of the quinoa grain. Conditioning can be employed for the effect of tempering or regulating the moisture content. The moisture content can be adjusted by the addition or removal of water. A preferred conditioning technique includes the addition of clean water to quinoa grain immediately after preconditioning. Clean water is used because the water from the previous pre-conditioning contained the saponins that leached from the quinoa grain. The ratio of quinoa to clean water (w/v) can be adjusted to include ratios such as 0.1:1 or 0.5:1; 2:1; 3:1; 4:1; 5:1; 20:1 or similar ratios, preferably 1:1. Residence time of tempering can be adjusted in the range of 30 seconds to 720 minutes depending on a given variety of quinoa, preferably about 160 minutes to about 260 minutes, most preferably about 210 minutes. The quinoa grain will absorb water and increase in moisture content in the range of about 12 to 60% moisture content of grain, preferably about 35% or about 45%. Tempering may occur at a temperature range of 0-100° C., preferably ambient temperature. After tempering, excess water is allowed to drain.

Germination:

The term “germination”, or “germinated” or “germinating”, is used herein to indicate a step of treatment to increase enzyme activity, maintain fermentable carbohydrates, and control microbial growth, such as regulating the sprouting of quinoa grain in such a manner to increase enzyme activity, maintain fermentable carbohydrates, and control microbial growth. Germination may occur at a temperature range of 0-100° C., preferably about 5° C. to about 15° C., most preferably about 10-11° C. It is also preferable to circulate air through the quinoa grain and allow the quinoa grain to maintain moisture content of about 35% to about 45% during the germination process. Residence time of germination can be adjusted in the range of 30 seconds to 14 days depending on a given variety of quinoa, more preferably about 48 hours to about 72 hours, most preferably about 60 hours. At the end of germination the quinoa grain is called “green quinoa malt.” Preferably, germination is immediately followed by incubation. Alternatively, germination can be followed by drying. When drying is employed, a preferred drying method occurs in a rapid time to minimize microbiological growth and product deterioration, as well as minimize damage to active enzymes. The dried green quinoa malt can be stored until further use in the incubation step, below. Alternatively, the dried green quinoa malt can be further treated by roasting, milling, particle size reduction and combinations thereof.

Incubation:

The term “incubation”, or “incubating”, is used herein to indicate a step of treatment where the germinated, mostly dry, quinoa is added to excess water to create a slurry which pulls the carbohydrates into the solution, such as by heat tempering. A preferred incubation technique includes adding water to green quinoa malt and heating under agitation. The ratio of quinoa to water (w/v) can be adjusted to include ratios such as 0.1:1 or 0.2:1, 0.33:1, 0.5:1; 1:1, 2:1; 3:1; 4:1; 5:1; 20:1 or similar ratios, preferably 3:1. Incubation may occur at a temperature range of 0-100° C., preferably about 32° C. to about 42° C., most preferably about 37° C. Residence time of incubation can be adjusted in the range of 30 seconds to 720 minutes depending on a given variety of quinoa, preferably about 30 minutes to about 120 minutes, most preferably about 60 minutes. Incubation is preferably followed by conversion.

Conversion:

The term “conversion”, or “converted” or “converting”, is used herein to indicate a step of treatment where the complex carbohydrates are changed, or “converted”, to simple carbohydrates, such as by cooking. A preferred conversion technique follows incubation and includes increasing the heat of the green quinoa malt and water slurry of incubation while under agitation. Conversion may occur at a temperature range of 0 to −100° C., preferably about 67° C. to about 87° C., most preferably about 77° C. Residence time of conversion can be adjusted in the range of 30 seconds to 720 minutes depending on a given variety of quinoa, preferably about 15 minutes to about 60 minutes, most preferably about 30 minutes. Conversion is preferably followed by reduction. After conversion the liquid slurry has a sweet taste.

Reduction:

The term “reduction”, or “reduced” or “reducing”, is used herein to indicate a step of treatment to drive off water and condense the liquid slurry, such as by evaporation. A preferred reduction technique follows conversion and includes maintaining or increasing the heat of conversion to drive off water or evaporate water and condense the liquid slurry. The reduced liquid slurry has a much sweeter taste than the converted liquid slurry and is a sweet quinoa product of the invention. The reduced liquid slurry may be dried into a sweet powdered quinoa product with an even greater sweet taste than the reduced liquid slurry and converted liquid slurry.

It is further contemplated that the process can be performed without reduction wherein a condensed liquid slurry is not required. However, such a product will not yield a product having the same concentrated sweetness as the reduced liquid slurry.

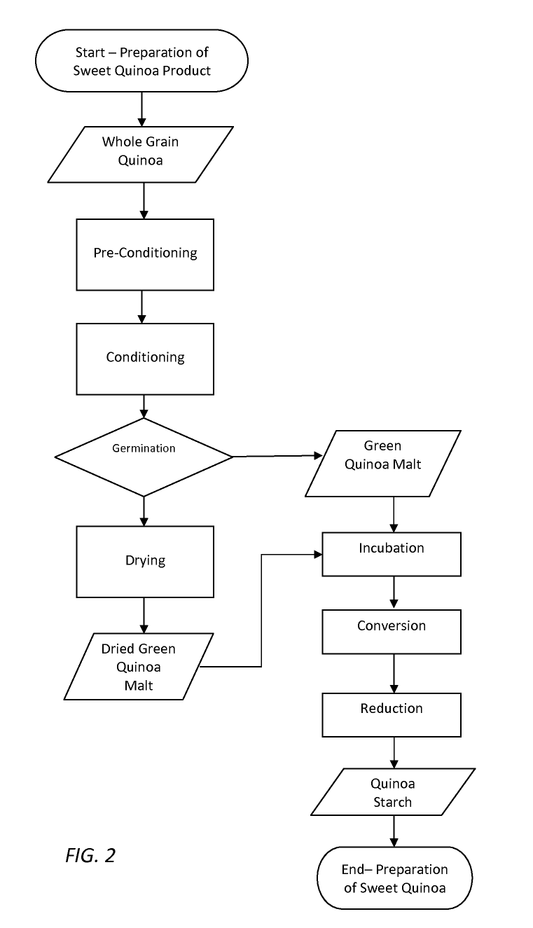

Processing the grain as outlined above produces a novel edible sweet liquid or sweet powdered quinoa product of the invention. It will be understood by those skilled in the art that the process disclosed herein can be operated with appropriate modifications and variations to obtain the afore-mentioned products. The process disclosed herein and illustrated in FIG. 2 is designed to obtain edible sweet quinoa product with novel characteristics as discussed above.

All references cited in the present application are incorporated in their entirety herein by reference to the extent not inconsistent herewith.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps or features.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. A method of processing quinoa grain comprising the steps of:
pre-conditioning the quinoa grain;
moist heating the quinoa grain; and
dry heating the quinoa grain, whereby the process yields an edible quinoa product.

2. The method according to claim 1 wherein the pre-conditioning is selected from the group consisting of mechanical abrasion, washing and combinations thereof.

3. The method according to claim 1 wherein the pre-conditioning includes the steps of:
abrasion of the quinoa grain;
quick washing the abraded quinoa grain with stirring, agitation, spray or counter current extraction during the washing; and
draining or centrifugation of the quick-washed quinoa grain to remove the wash solution, whereby the quick wash minimizes penetration of the water-soluble saponins into the quinoa grain.

4. The method according to claim 1 wherein the pre-conditioning includes abrasion followed by a plurality of quick washes.

5. The method according to claim 4 wherein one or more of the plurality of quick washes include stirring, agitation, spray or counter current extraction of the abraded quinoa grain followed by draining or centrifugation of the wash solution from the quick-washed quinoa grain.

6. The method according to claim 4 wherein the first of the plurality of quick washes employs a residence time of about 30 seconds to about 2 minutes and a subsequent wash employs a residence time of about 2 minutes to about 10 minutes.

7. The method according to claim 1 wherein the pre-conditioning is selected from the group consisting of mechanical abrasion, washing, polishing, peeling, aspiration, air classification, sieving, pneumatic pressure, vacuum, nixtamalization, rinsing, solvent leaching of the quinoa grain and combinations thereof.

8. The method according to claim 1 wherein the moist heating is selected from the group consisting of steam cooking, pressure cooking and combinations thereof.

9. The method according to claim 1 wherein the moist heating is performed by steaming the quinoa grain substantially immediately after the pre-conditioning step.

10. The method according to claim 9 wherein the pre-conditioning step is controlled in duration to produce a quinoa grain wherein only the outer portion of the grain is moistened.

11. The method according to claim 1 wherein the dry heating is selected from the group consisting of baking, toasting, dehydrating and combinations thereof.

12. The method according to claim 1 wherein the quinoa grain is dry heated by a plurality of bakes in a convection oven.

13. The method according to claim 12 wherein the quinoa grain is dry heated using a first bake of about 10 minutes at about 250° F. followed by a second bake of about 2 minutes at about 250° F.

14. A method of processing quinoa grain comprising the steps of:
pre-conditioning the quinoa grain;
conditioning the pre-conditioned quinoa grain;
germinating the conditioned quinoa grain;
incubating the germinated quinoa grain;
converting the incubated quinoa grain; and
reducing the converted quinoa grain, whereby the process yields a sweet quinoa product.

15. The method according to claim 14 wherein the pre-conditioning is selected from the group consisting of mechanical abrasion, washing and combinations thereof.

16. The method according to claim 14 wherein the pre-conditioning includes the steps of:
abrasion of the quinoa grain;
quick washing the abraded quinoa grain with stirring, agitation, spray or counter current extraction during the washing; and
draining or centrifugation of the quick-washed quinoa grain to remove the wash solution, whereby the quick wash minimizes penetration of the water-soluble saponins into the quinoa grain.

17. The method according to claim 14 wherein the pre-conditioning includes abrasion followed by a plurality of quick washes.

18. The method according to claim 17 wherein one or more of the plurality of quick washes include stirring, agitation, spray or counter current extraction of the abraded quinoa grain followed by draining or centrifugation of the wash solution from the quick-washed quinoa grain.

19. The method according to claim 17 wherein the first of the plurality of quick washes employs a residence time of about 30 seconds to about 2 minutes and a subsequent wash employs a residence time of about 2 minutes to about 10 minutes.

20. The method according to claim 14 wherein the pre-conditioning is selected from the group consisting of mechanical abrasion, washing, polishing, peeling, aspiration, air classification, sieving, pneumatic pressure, vacuum, nixtamalization, rinsing, solvent leaching of the quinoa grain and combinations thereof.

21. The method according to claim 14 wherein the conditioning is performed by evaporating water from the grain to yield grain with a moisture content of about 12 to about 60%.

22. The method according to claim 22 wherein the grain is conditioned to a moisture content of about 35 to about 45%.

23. The method according to claim 14 wherein the conditioning step immediately follows the pre-conditioning step and the conditioning is performed by immersing the preconditioned quinoa grain in clean water.

24. The method according to claim 14 wherein the germination step is performed at a temperature range of about 5° C. to about 15° C. and a residence time of about 48 hours to about 72 hours.

25. The method according to claim 24 wherein the germination step is performed while circulating air through quinoa grain and quinoa grain is maintained in a moisture content of about 35% to about 45% during the germination process.

26. The method according to claim 14 wherein the incubation step is performed by adding water to the quinoa grain and heating the mixture under agitation.

27. The method according to claim 26 wherein the ratio of quinoa to water (w/v) is from about 1:1 to about 5:1.

28. The method according to claim 14 wherein the conversion step is performed by cooking the green quinoa malt at about 67° C. to about 87° C. for about 15 minutes to about 60 minutes.

29. The method according to claim 14 wherein the liquid slurry is reduced by evaporation, whereby the reduced liquid slurry has a more concentrated sweetness that the liquid slurry prior to reduction.

30. A method of processing quinoa grain comprising the steps of:
pre-conditioning the quinoa grain;
conditioning the pre-conditioned quinoa grain;
germinating the conditioned quinoa grain at a temperature range of about 5° C. to about 15° C. and a residence time of about 48 hours to about 72 hours while circulating air through quinoa grain and maintaining a moisture content of about 35% to about 45% during the germination process;
incubating the germinated quinoa grain;
converting the incubated quinoa grain; and
reducing the converted quinoa grain, whereby the process yields a sweet quinoa product.
